(19) United States
(12) Patent Application Publication
(10) Pub. No.: US 2021/0253061 A1
(43) Pub. Date: Aug. 19, 2021

(54) PERSONAL SECURING SYSTEM FOR SECURING PEOPLE IN VEHICLES WITH REVERSIBLY MOUNTED VEHICLE SEATS

(71) Applicant: AMF-Bruns GmbH & Co. KG, Apen (DE)

(72) Inventor: Gerit Bruns, Bad Zwischenahn (DE)

(21) Appl. No.: 16/996,226

(22) Filed: Aug. 18, 2020

Related U.S. Application Data
(60) Provisional application No. 62/977,422, filed on Feb. 17, 2020.

(51) Int. Cl. B60R 22/48; B60R 22/26; B60R 21/015; B60N 2/68

(52) U.S. Cl. CPC B60R 22/48; B60R 22/26; B60R 2022/4858; B60N 2/688; B60R 2022/4816; B60R 21/01546

(57) ABSTRACT

A personal securing system for securing people in vehicles with reversibly mounted vehicle seats includes a seat detector adapted to monitor occupancy of the vehicle seat, at least one belt buckle adapted to be brought into engagement with a buckle tongue, a belt buckle detector on the belt buckle adapted to provide a signal when the belt buckle is in engagement with the buckle tongue, and a controller adapted to process the signals recorded by the seat detector and the belt buckle detector. The controller provides an alarm signal to an alarm device when, with a vehicle seat being occupied, the respective belt buckle is not in engagement with the buckle tongue. The controller has an autonomous power storage device electrically decoupled from the vehicle for providing a dedicated power supply for the controller, the seat detector, the belt buckle detector, and the alarm device.

### CROSS-REFERENCE TO RELATED APPLICATION

This application claims priority to U.S. Provisional Patent Application No. 62/977,422, filed Feb. 17, 2020, the entirety of which is incorporated herein by reference.

### TECHNICAL FIELD

This application relates to a personal securing system for restraining people in vehicles with reversibly mounted vehicle seats. This application also relates to a seat assembly for reversible coupling to vehicles having a personal securing system, as well as associated vehicles and methods.

### BACKGROUND

Vehicles with reversibly mounted vehicle seats are used to flexibly adapt the respective arrangement of the vehicle seats to the current demands in regard to the number of people to be conveyed and other items.

Vehicles of that kind are used, for example, by transport services for transporting people with a physical impairment like for example wheelchair users or children. In cases in which wheelchair users are being transported the vehicle seats are to be quickly removed and then re-fitted as required.

Those special transport services are repeatedly used on a daily basis for transporting fluctuating numbers of people having different needs, for example due to their mobility. Especially designed vehicles with vehicle seats which can be quickly reversibly fitted are used for that purpose.

Restraining people in vehicles of that kind represents a particular challenge. Conventional personal securing systems for personal restraint detect whether the people on the occupied vehicle seats are buckled up. For that purpose the personal securing systems communicate with the central vehicle control system and are coupled to the central power supply by the vehicle battery. Conventional personal securing systems cannot therefore be used in vehicles of such transport services by virtue of regular fitment and removal of the vehicle seats.

In addition, with conventional personal securing systems, a power supply is frequently provided only when the engine is switched on, and the system can then detect whether the passengers on the occupied vehicle seats are buckled up. Particularly in the case of the above-described transport services the passengers like children or people with physical or mental impairments are firstly to be buckled up by a caregiver or companion in the vehicle or a check has to be made to ensure they are properly buckled up. The caregiver or companion however only discovers whether all passengers are actually buckled up when the engine is switched on. Furthermore, it is necessary to know which passengers are not buckled up as otherwise all passengers have to be checked. The amount of time that this involves is perceived as being a disadvantage.

Therefore, it would be desirable to provide a personal securing system for securing people in vehicles with reversibly mounted vehicle seats, which as extensively as possibly overcomes the above-described disadvantages. It is desirable to provide a personal securing system which, in the case of vehicle seats which can be fitted flexibly and also quickly and reversibly in a vehicle, make it possible to find out in regard to an occupied vehicle seat whether the passenger is buckled up, and also still remains so while traveling.

### SUMMARY

According to a first embodiment, a personal securing system is provided for securing people in vehicles with reversibly mounted vehicle seats. The personal securing system includes a seat detector which can be fitted into the seat surface of a vehicle seat and is adapted to continuously monitor occupancy of the vehicle seat and to provide a signal when the vehicle seat is occupied, at least one belt buckle which can be connected to the vehicle seat and is adapted to be brought into engagement with a buckle tongue, the belt buckle further having a belt buckle detector adapted to monitor the position of the buckle tongue and to provide a signal when the belt buckle is in engagement with the buckle tongue, and a controller which can be connected to the vehicle seat and which is connected in signal-conducting relationship to the seat detector and the belt buckle detector and is adapted to process the signals recorded by the seat detector and the belt buckle detector and to provide an alarm signal when with a vehicle seat being occupied the respective belt buckle is not in engagement with the buckle tongue. The system also includes an alarm device connected in signal-conducting relationship to the controller for producing an alarm after reception of an alarm signal. The controller has an autonomous power storage device electrically decoupled from the vehicle for providing a dedicated power supply for the controller, the seat detector, the belt buckle detector and the alarm device.

Such a personal securing system permits autonomous person securing by an automatically operating power storage device which is electrically independent of the vehicle, preferably being decoupled, for providing its own power supply. The personal securing system can thus be fixed to or fitted or integrated into a vehicle seat and thus mounted jointly with the seat reversibly in the vehicle. The laborious and expensive connection of power-transmitting and signal-transmitting lines from the central controller and for example the vehicle battery to the personal securing system is thus eliminated; the power storage device for the controller of the personal securing system is independent of the electrical power supply of the vehicle and can be operated independently thereof. At the same time the securing of people in vehicles is reliably ensured as the seat detector provides for preferably continuously or discontinuously monitoring seat occupancy at adjustable, preferably short time intervals, while in the case of an occupied vehicle seat the signals of the belt buckle detector are further processed or evaluated by the controller to produce an alarm signal when a passenger is not buckled up. The arrangement in that respect provides for monitoring whether all passengers are buckled up, both prior to the journey and also continuously during the journey.

The personal securing system according to this embodiment can advantageously be integrated in also already existing vehicle seats in order overall to increase occupant safety. The personal securing system according to this embodiment is preferably so designed that it can also be subsequently retro-installed after initial equipping of the vehicle.

The alarm device which is connected to the controller and which can also be fed by the power storage device already provides an alarm signal during the buckling-up process if individual passengers are not buckled up preferably irrespective of whether the ignition of the vehicle is operational. The respective responsible caregiver or companion who possibly has to buckle up the passengers thus knows at an early time that they have to check the belt buckles once more.

The alarm device is fixedly pre-installed on the vehicle and connected in signal-conducting relationship to the controller by a wireless connection. In such a case the alarm device can be fed by the power supply of the vehicle, for example by the vehicle battery.

In that case the belt buckle may be connected to the vehicle seat both indirectly and also directly, which allows for the transmission of force between the vehicle seat and the belt buckle which are jointly mounted reversibly in the vehicle.

A signal-conducting connection between the controller and the seat detector and the belt buckle detector in accordance with this embodiment can be wired but also by wireless transmission, for example, by radio, Bluetooth, WLAN or other forms of wireless data transfer.

A power storage device according to this embodiment can further be provided both in a replaceable manner, for example in the form of batteries, and also chargeable in the form of accumulators. Alternative power storage devices, coupled to autonomous sources for preferably electrical energy, like for example solar cells, can also serve as power storage device in accordance with the invention.

According to another embodiment, the controller is adapted to provide the alarm signal to the alarm device only with the expiry of a delay time after detection of seat occupancy. Therefore the alarm is produced after seat occupancy for the first time after expiry of the delay time and then in the course of the journey, as the delay time has already expired, it is produced immediately when a passenger unbuckles. The delay time provides that after the passenger sits on the respective vehicle seat a predetermined period of time initially remains for the passenger to buckle up or to be buckled up. Accordingly safety while traveling is ensured by dispensing with the delay and prior to the journey while the passengers are sitting down and buckling up a sufficient period of time is afforded before any alarm can be produced.

Preferably the controller has a delay circuit for specifying the delay time and the power storage device provides a power supply for the delay circuit. Accordingly the delay time can be predetermined by the delay circuit, the delay circuit preferably being connected in signal-conducting relationship to a user interface. Accordingly the driver or the caregiver or companion who buckles up the passengers or monitor buckling-up can predetermine how much time is required for buckling up so that the alarm signal can be provided and an alarm produced at the earliest after expiry of that time. By virtue of the delay circuit being supplied with current by the power supply device, the circuit is operable independently of the vehicle so that even when the engine is switched off a delay time can be specified and an alarm signal can be produced after expiry of that delay time.

According to yet another embodiment, the controller has the alarm device, where the alarm device is in the form of an acoustic and/or optical alarm device for producing an alarm sound and/or an optical alarm. An alarm sound or an optical alarm signal reliably indicates at each of the seats with a personal securing system that the relevant person in question is not buckled up. In that respect both an optical and also an acoustic alarm signal permit reliable alarm generation. Particularly preferably the alarm is acoustic as in that way the alarm device can be fitted or positioned even at regions which are difficult to inspect and are inaccessible, without the alarm function being impaired. That alarm can also be perceived at a distance of some meters so that drivers have their attention drawn by the acoustic signal to a passenger being unbuckled even while driving.

According to a further embodiment, the controller has a charge state monitoring unit connected in signal-conducting relationship to the power storage device and in signal-conducting relationship to the alarm device, wherein the alarm signal is a first alarm signal and the charge state monitoring unit is further adapted to provide a second alarm signal to the alarm device when the charge state falls below a predefined minimum charge state. Preferably the alarm device, after the reception of the second alarm signal, produces a second alarm which is different from the first alarm. The power storage device is thus continuously monitored by the charge state monitoring unit, thereby ensuring that the personal securing system does not unintentionally fail while traveling by the power storage device being completely discharged. This configuration therefore ensures reliable operation of the personal securing system. Preferably the minimum charge state is so selected that a predefined remaining distance, preferably in a region of between 500 km and 1000 km, can be covered until the power storage device is completely discharged after generation of the second alarm signal.

Preferably, the controller is connected by a respective power line and a signal line to the seat detector, the belt buckle detector and preferably the alarm device. A cabled connection of the controller to the other components of the personal securing system, namely the seat detector, the belt buckle detector and preferably also the alarm device, provides a robust reliable personal securing system. Wireless signal transmission is subject to environmental influences which act as interference phenomena. Such interference cannot adversely affect reliable operation of the personal securing system by virtue of wired signal transmission and power supply. As such, the functionality of the personal securing system is ensured even upon repeated fitting and removal of a vehicle seat which has such a personal securing system.

The belt buckle detector has a Hall effect sensor and a magnet, in particular a permanent magnet, wherein the Hall effect sensor is adapted to detect a change in position of the buckle tongue by a change in the acting magnetic field. The belt buckle detector is thus in the form of a Hall effect detector. Hall effect detectors comprise crystalline doped semiconductor layers which are as thin as possible and which laterally have generally four electrodes. A current is fed in through the two opposite disposed electrodes, wherein the Hall voltage is taken off by the two electrodes in orthogonal relationship therewith in the belt buckle. When a magnetic field perpendicular to the layer flows around such a Hall effect sensor it produces an output voltage proportional to the amount of the vector product from the magnetic flux density and the current provided by the power storage device. The magnetic field and thus the magnetic flux density is influenced by the exciter magnet in such a way that the output voltage changes and the belt buckle detector produces a signal indicating that the buckle tongue has been introduced into the respective belt buckle.

The personal securing system further includes a transmitting unit connected to the controller in signal-conducting relationship, in particular wired by a signal line, wherein the transmitting unit is connected by a wireless signal connection to a receiver unit associated with a vehicle and is adapted to send the signals provided by the controller, in particular the alarm signal, to the receiver unit. Accordingly the signals provided by the belt buckle detector and the seat detector can be provided even over relatively great distances, in particular within a vehicle.

Preferably, the transmitting unit is integrated into the controller. In that way the controller itself can wirelessly provide the signals detected by the belt buckle detector and the seat detector to an external receiver unit and/or the alarm unit.

In another embodiment, the receiver unit is connected in signal-conducting relationship, in particular wired by a signal line, to a signal processing unit associated with the vehicle, wherein the signal processing unit is adapted to process the signals provided by the transmitting unit and received by the receiver unit to carry out at least one of the following method steps:

providing an optical and/or acoustic signal when an alarm signal was provided by the controller,

providing a signal to a display unit, the signal containing information about the signals detected by the seat detector and/or the belt buckle detector, and

providing a signal to a central vehicle control system, the signal containing information about the signals detected by the seat detector and/or the belt buckle detector. Accordingly the signals provided by the belt buckle detector and the seat detector can be centrally collected and there converted into optical and/or acoustic signals and provided for quick and easy viewing by suitable caregivers or companions or vehicle drivers.

The signal processing unit processes the signals which one or more signal receiver units receive from one or more transmitting units. Accordingly the signals of all personal securing systems in a vehicle can be processed by just one signal processing unit which is preferably connected to a display unit, and corresponding optical and/or acoustic signals can be produced.

The signal processing unit is preferably coupled to an external current and voltage supply/or a vehicle battery.

Preferably the signal processing unit has a display unit and is adapted to provide an optical and/or acoustic signal.

The invention has been described hereinbefore in a first set of embodiments in relation to a personal securing system.

In a second set of embodiments, a seat assembly is provided for reversible coupling to a vehicle. The object of the invention is attained in such embodiments by providing a seat assembly for reversible coupling to a vehicle, having a personal securing system according to the description above, a vehicle seat having a seat surface in which the seat detector is fitted, and a quick-action coupling device for fast reversible coupling of the vehicle seat to the vehicle, the belt buckle being connected to the vehicle seat and the controller being arranged at the vehicle seat.

A seat assembly with a personal securing system according to embodiments of the invention achieves the above-described effects and advantages of the personal securing system. The preferred configurations remain the same with this set of embodiments.

In a third set of embodiments, a vehicle is provided, in particular a passenger vehicle for transporting passengers. The object of the invention is attained in such embodiments by providing the vehicle with a seat assembly as described above, at least one retractor restraint system having a buckle tongue which can be brought into engagement with the corresponding belt buckle of the personal securing system, at least one coupling interface which can be reversibly coupled to the corresponding quick-action coupling device of the vehicle seat, and a vehicle battery for providing a power supply for the vehicle, wherein the power storage device of the personal securing system is an autonomous power storage device and is electrically decoupled from the vehicle battery. Similar technical advantages and preferred configurations from the previous embodiments apply in a similar manner to these embodiments involving a vehicle.

In a fourth set of embodiments, a method is provided of securing people in vehicles. The object of the invention is attained in such embodiments by providing a method including the steps:

providing a seat assembly with a vehicle seat which has a personal securing system, with an autonomous power storage device as the power supply for a controller, a seat detector, a belt buckle detector and an alarm device,

reversibly fitting the vehicle seat with the personal securing system in the vehicle,

providing a power supply by the power storage device for the controller, the belt buckle detector, the seat detector and preferably the alarm device,

detecting occupancy of a vehicle seat by a seat detector,

detecting a closed state in which the belt buckle is in engagement with a buckle tongue by a belt buckle detector,

processing the information detected by the seat detector and the belt buckle detector,

providing a first alarm signal when with a vehicle seat occupied the associated belt buckle is not moved into the closed state, and

producing a first alarm after reception of the first alarm signal.

Thus, according to the fourth set of embodiments, there is proposed a method of securing people in vehicles, which by the provision of a seat assembly having an autonomous power storage device, makes it possible to ensure occupancy of a vehicle seat and the closed state of the belt buckle independently of the power supply of the vehicle, for example by the vehicle battery. The provision of the seat assembly and reversible fitment of the vehicle seat with the personal securing system can thus be carried out independently of operation of the vehicle. Similar technical advantages and preferred configurations from the previous embodiments apply in a similar manner to these embodiments involving a method.

In some embodiments, the method further includes the steps:

checking the charge state of the power storage device,

providing a second alarm signal when the charge state is below a predefined minimum charge state, and

producing a second alarm after reception of the second alarm signal.

The second alarm is, in that case, preferably different from the first alarm. Such checking of the charge state of the power storage device can ensure in operation that occupancy of the vehicle seat and the closed state can be reliably detected as the detector used for that purpose like the seat detector and the belt buckle detector can be reliably supplied with power from the power storage device. Such a method of checking the charge state, that is integrated into the personal securing method, thus enhances the fail-safe aspect.

In another embodiment, the method includes the step: specifying a delay time by a delay circuit of the personal securing system, wherein the first alarm signal is provided only with the expiry of the delay time after detection of a seat occupancy and the first alarm is produced. Therefore the method provides a period of time in which the vehicle occupants can be buckled up before any alarm signal is produced. Otherwise that alarm signal would be produced immediately after the vehicle seat was occupied and would unnecessarily disturb and adversely affect the driver and the passengers.

In embodiments of the method, the first alarm signal is produced immediately when after expiry of the delay time the belt buckle is separated from the belt tongue again and seat occupancy is still detected. Thus, during the journey, after the delay time has expired for the first time, an alarm signal is produced immediately whenever the belt buckle is separated from the buckle tongue. In that way safety is enhanced in particular while traveling and a delay between unbuckling and production of the alarm while traveling, which in the case of an accident could lead to personal injury, is avoided.

According to a further embodiment, the method further includes the steps:

replacing or charging the power storage device,

checking the current supply or the voltage supply,

producing a first alarm signal adapted that the current supply or voltage supply is present,

checking the belt buckle detector,

again producing the first alarm signal when the belt buckle detector does not provide a signal and/or does not detect engagement of the belt buckle and the buckle tongue, or

producing a second alarm signal and preferably the second alarm signal when the belt buckle detector provides a signal and/or detects engagement of the belt buckle and the buckle tongue,

checking the seat detector,

again producing the first alarm signal when the seat detector does not provide a signal and/or does not detect seating position occupancy, or

producing a second alarm signal when the seat detector provides a signal and/or detects seat occupancy.

Accordingly, the functionality of the personal securing system is tested and ensured even upon a system restart or replacement or charging of the power storage device.

### BRIEF DESCRIPTION OF THE DRAWINGS

The accompanying drawings, which are incorporated in and constitute a part of this specification, illustrate one or more embodiments of the invention and, together with the general description given above and the detailed description given below, explain the one or more embodiments of the invention.

FIG. 1A is a schematic view of a personal securing system according to a first embodiment of the invention.

FIG. 1B is a schematic view of a personal securing system according to a second embodiment.

FIG. 2 is a schematic view of a seat assembly including the personal securing system of FIG. 1A.

FIG. 3 is a schematic view of a vehicle including the seat assembly of FIG. 2.

FIG. 4 is a flow chart showing method steps performed by the controller in accordance with another embodiment.

FIG. 5 is a flow chart showing method steps of the functional testing method.

FIG. 6 is a flow chart showing method steps of securing people in vehicles.

FIG. 7 is a flow chart showing method steps for checking the charge state.

### DETAILED DESCRIPTION

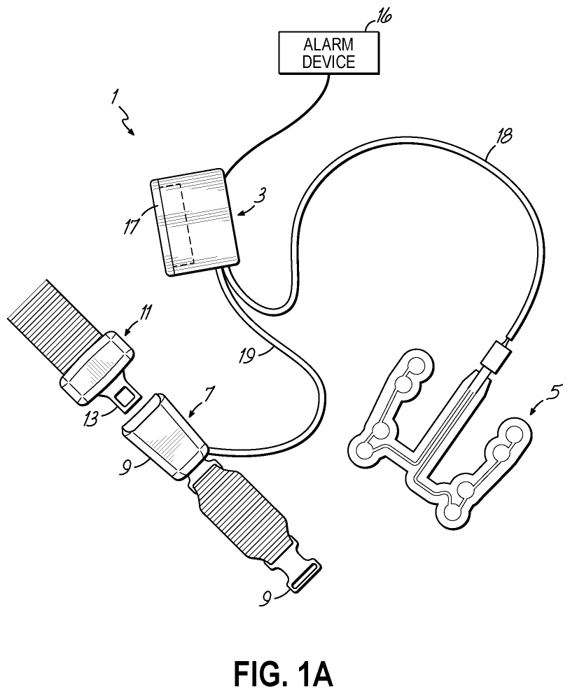

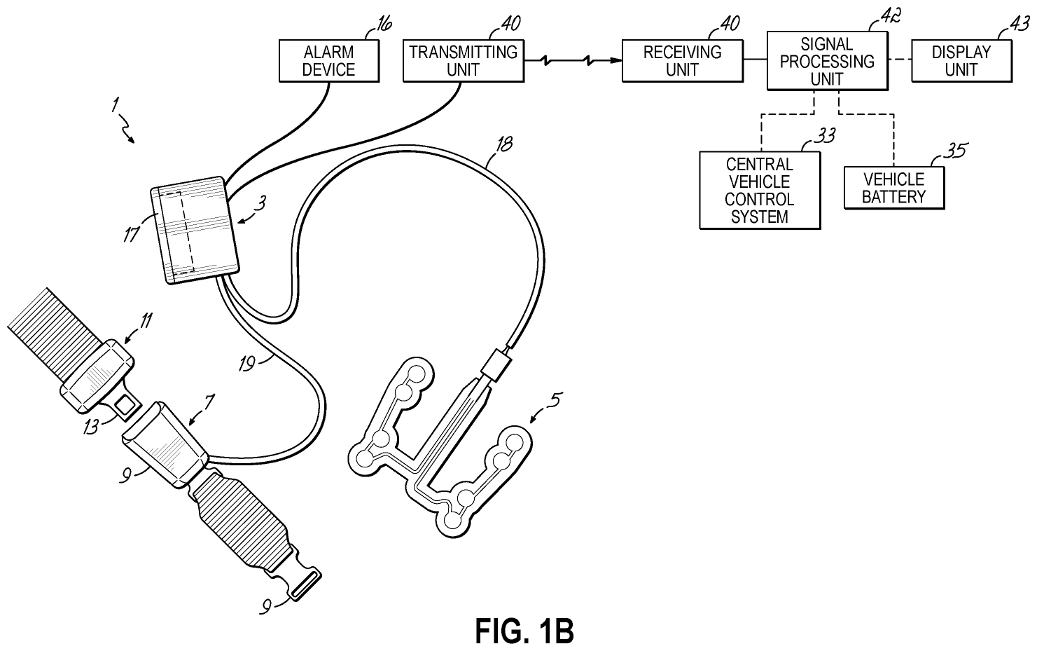

FIG. 1A shows a personal securing system 1 for securing people in vehicles with reversibly mounted vehicle seats.

The personal securing system 1 has a controller 3 connected to a seat detector 5 and a belt buckle 7 including a belt buckle detector 9 in signal-conducting relationship.

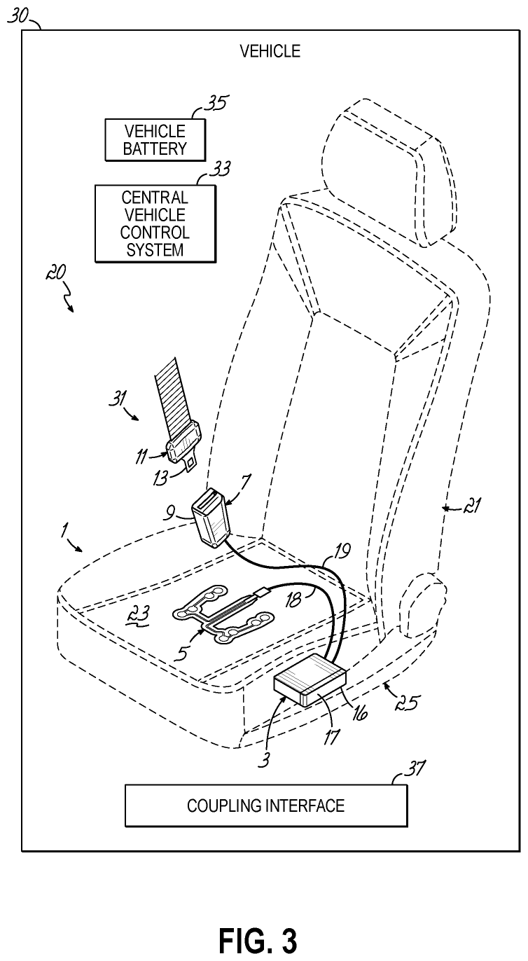

The controller 3 is adapted to process the signals detected by the seat detector 5 and the belt buckle detector 9 and provide an alarm signal. The alarm signal is provided when, in the installed state of the personal securing system 1 in which it is fixed to a reversibly mounted vehicle seat, occupancy of a vehicle seat is detected by the seat detector 5 and the belt buckle detector 9 further detects that the belt buckle 7 is not in engagement with a cooperating buckle tongue 11 of a retractor restraint system (see FIG. 3).

The belt buckle detector 9 is preferably a Hall effect sensor and the buckle tongue 11 has an exciter magnet 13 detected by the Hall effect sensor 9 when it moves into the magnetic field of the Hall effect sensor 9.

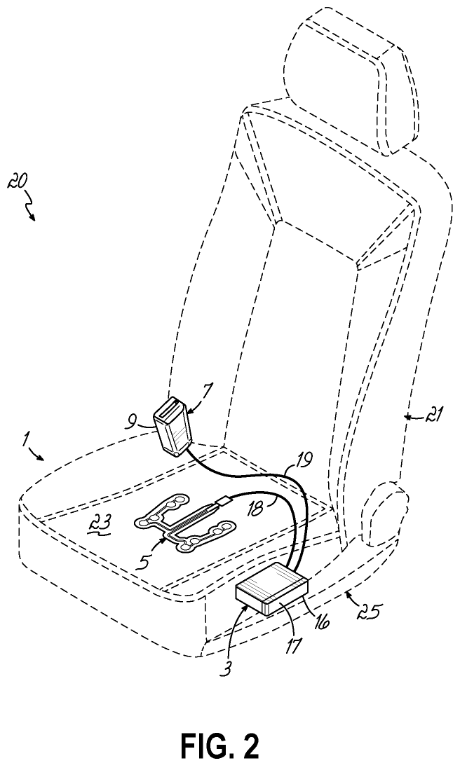

In addition the belt buckle 7 has a mounting interface 15 adapted to be connected to a vehicle seat 21 (see FIG. 2).

The personal securing system 1 further has an alarm device 16 connected in signal-conducting relationship to the controller 3 and adapted to produce an alarm upon reception of an alarm signal from the controller 3.

The controller 3 further has an autonomous power storage device 17 electrically decoupled from the vehicle for providing a dedicated power supply for the controller 3, the seat detector 5, the belt buckle detector 9 and preferably the alarm device 16. The power storage device 17 is for example in the form of a battery, a rechargeable accumulator, and possibly coupled to an autonomous electrical energy source in the form for example of a solar cell unit.

In that respect, it is also in accordance with the invention if the power storage device 17 is not directly part of the controller 3 but is at least indirectly connected thereto.

For signal-conducting and current-conducting connection, the seat detector 5 is connected to the controller 3 by a first current or signal cable 18 and the belt buckle detector 9 is connected to the controller 3 by a second current or signal cable 19.

The expression current or signal cable is used to denote a cable in which either two cables, namely a current cable and a signal cable, extend in mutually adjacent relationship, or in which both cables extend in mutually parallel relationship in a common insulating sheath for data connection.

The personal securing system 1 shown in FIG. 1B differs from that shown in FIG. 1A by a transmitting unit 40 which is connected by cable to the controller 3.

It is also in accordance with the invention to provide a wireless signal connection between the controller 3 and the transmitting unit 40.

The transmitting unit 40 is adapted to send the signals of the belt buckle detector 9 and the seat detector 5, that are processed by the controller 3, and/or the alarm signal provided by the controller 3, to an external receiver unit 41. In that case transmission of those signals by the transmitting unit 40 to the receiver unit 41 is preferably effected wirelessly, for example by radio, WiFi, WLAN, Bluetooth, NFC, ZigBee or other standards of wireless data transfer.

The signals processed by the controller can be provided by the wireless signal transmission between the transmitting unit 40 and the receiver unit 41 over great distances for further processing and/or evaluation. The receiver unit 41 is connected to a signal processing unit 42 by a wired signal line.

It is also in accordance with the invention to provide signal transmission between the receiver unit 41 and the data processing unit 42, by a wireless signal connection.

The signal processing unit 42 is adapted to further process and prepare the signals received by the receiver unit 41 and then to provide those processed signals for example to a display unit 43 and/or the central vehicle control system 33.

The signal processing unit 42 is preferably connected to the central vehicle control system 33 of a vehicle (not shown) and a vehicle battery 35 of the vehicle. Accordingly the current and voltage supply of the signal processing unit 42 is provided by the vehicle battery 35.

It is further in accordance with the invention that the signal processing unit 42 is integrated into the display unit 43.

The display unit 43 is adapted to display the signals processed by the signal processing unit 42, or convert them into optical signals and/or acoustic signals. In that case the converted signals preferably permit conclusions about the signals detected by the seat detector 5 and the belt buckle detector 9.

By way of example the display unit 43 can provide a first acoustic signal when the seat detector 5 detects seat occupancy, and a second acoustic signal when the belt buckle detector 9 detects the buckle tongue 11 on the belt buckle, in order to provide a third acoustic signal if after expiry of a predefined delay time only one of the two signals is provided.

The display unit 43 can be used in addition to the alarm unit 16 or as an alternative thereto.

Further preferably signals of different personal securing systems 1 are provided for the display unit 43 by the receiver unit 41 and the signal processing unit 42. In that case the display unit 43 is adapted to monitor the buckle-up situation of each of the personal securing systems 1, defined by the signals from the seat detector 5 and the belt buckle detector 9, and to display same, or provide corresponding optical signals.

In alternative embodiments it can equally be provided that the display unit 43 is part of a central display unit (not shown) of the vehicle.

FIG. 2 shows a seat assembly 20 according to embodiments of the invention.

The seat assembly 20 includes the personal securing system 1 shown in FIG. 1A and a vehicle seat 21 having a seat surface 23 into which the seat detector 5 is embedded or fitted.

The vehicle seat 21 further includes a quick-action coupling device 25 for rapid reversible coupling of the vehicle seat 21 to the vehicle (see FIG. 3). The quick-action coupling device 25 is preferably arranged at the underside of the seat 21 and can preferably be brought into engagement with a corresponding coupling interface 37 (see FIG. 3) on a vehicle floor.

The vehicle seat 21 further has a mounting interface (not shown) at which the corresponding mounting interface 15 (see FIG. 1A) of the belt buckle 7 can be mounted.

The current or signal cables 18, 19 are preferably embedded in the vehicle seat 21, in particular in its seat upholstery.

The controller 3 is arranged at the vehicle seat 21 and is fixed thereto in such a way that the power storage device 17 is accessible from the exterior to optionally replace it.

The personal securing system 1 is fixed to the vehicle seat 21 in such a way that, together with the vehicle seat 21, it can be coupled to a vehicle or uncoupled therefrom again by the quick-action coupling device 25.

FIG. 3 shows a diagrammatic view of a vehicle 30 for transporting passengers.

The vehicle 30 has a seat assembly 20 with the personal securing system 1. In addition the vehicle has a retractor restraint system 31 including the buckle tongue 11. The buckle tongue 11 of the retractor restraint system 31 can be brought into engagement with the corresponding belt buckle 7 of the personal securing system 1 in order to secure or fix a passenger to the seat.

The vehicle 30 further includes a coupling interface 37 which can be coupled to the corresponding quick-action coupling device 25 of the vehicle seat 21 of the seat assembly 20. In addition the vehicle 30 has a central vehicle control system 33 and a vehicle battery 35 connected in signal-conducting relationship to the central vehicle control system 33. The vehicle battery 35 is adapted to provide the central power supply for the vehicle 30.

In this case the power storage device 17 of the controller 3 is an autonomous power storage device electrically decoupled from the vehicle battery 35.

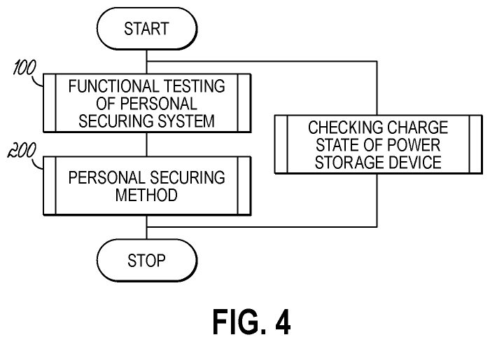

FIG. 4 shows a flow chart illustrating the mode of operation of the controller 3 in accordance with a method in one embodiment of the invention. The controller 3 is adapted, after charging or replacement of the power storage device 17, and before a personal securing method 200, to carry out method steps 100 for functional testing. In parallel with the method steps for personal securing 200 and optionally method steps for functional testing 100, the controller 3 is adapted to perform method steps for checking the charge state of the power storage device 17.

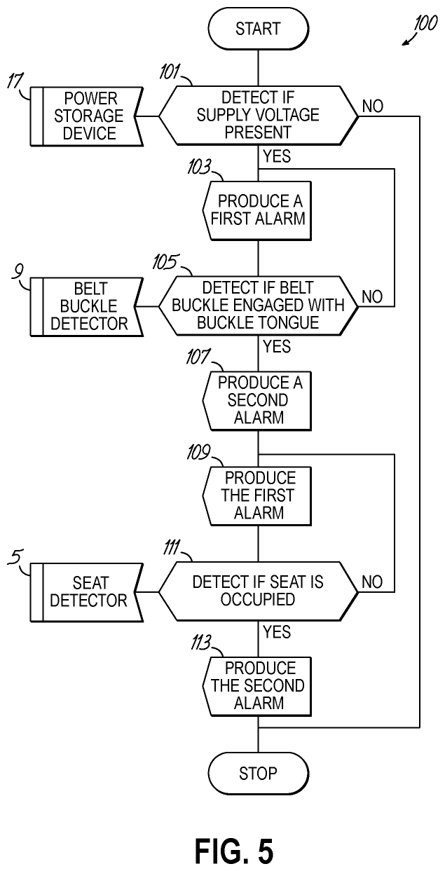

The method steps for functional testing 100 of the personal securing system 1 (see FIG. 1A) are shown in a flow chart in FIG. 5. The method steps include checking whether a recurring voltage, in particular a supply voltage, which is provided by the power storage device 17, is present.

If there is no voltage, then the further method steps 100 for functional testing of the personal securing system 1 are not carried out.

If a recurring voltage is detected in a method step 101, then a first alarm, preferably an acoustic alarm, is produced in a method step 103, by an alarm signal provided by the controller 3. A method step 105 involves detecting by the belt buckle detector 9 whether the belt buckle 7 is in engagement with the buckle tongue 11. In a situation when the belt buckle 7 is not in engagement with the buckle tongue 11 method step 103 is carried out again and an alarm is produced. Method step 105 is then carried out again.

In situations in which the belt buckle 7 is in engagement with the buckle tongue 11, a method step 107 involves producing a second alarm which is different from the first alarm. Then the first alarm is produced again in a method step 109 so that method steps 107 and 109 involve the implementation of a sequence of the second alarm and the first alarm, which shows that the belt buckle 7 is in engagement with the belt tongue 11.

A method step 111 involves checking by the seat detector 5 whether the seating position is occupied. If the seating position is not occupied, method step 109 is carried out again and the first alarm is produced once more. Method step 111 is then repeated.

In situations in which seating position occupancy is detected in method step 111, the second alarm is produced again in method step 113.

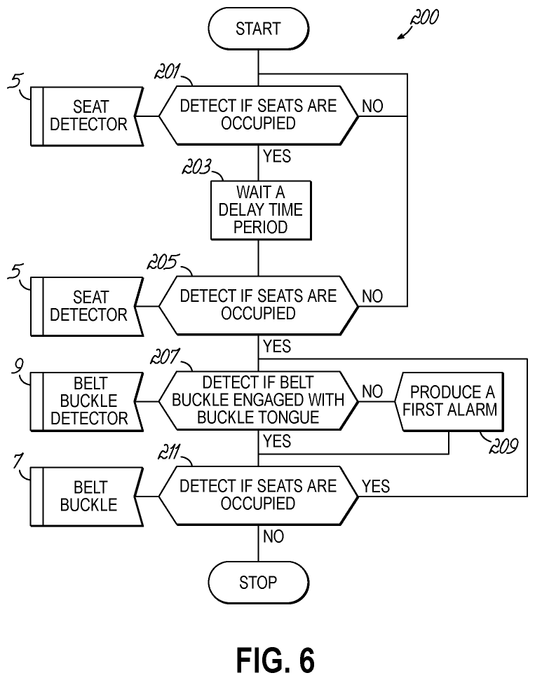

After the method steps shown in FIG. 5 or in ongoing operation, the method steps 200 shown in FIG. 6 are performed to secure people in vehicles.

A method step 201 involves checking the seating position occupancy by the seat detector 5. Method step 201 is repeated until seating position occupancy is detected. Then, method step 203 involves waiting for the expiry of a delay time which can preferably be predetermined by a delay circuit of the controller 3 of the personal securing system 1 shown in FIG. 1A.

After the expiry of that delay time, the seat detector 5 detects once again whether the seating position is also still occupied. If it is not occupied, method step 201 is repeated. If the seating position is occupied, that is then followed by method step 207 in which a check is made by the belt buckle detector 9 to see whether the belt buckle 7 is in engagement with the buckle tongue 11. If the belt buckle 7 is separated from the buckle tongue 11, the controller 3 provides a first alarm signal to an alarm device 16 (see FIG. 1A) which then produces a first alarm.

Method step 207 is then repeated until the belt buckle detector detects that the belt buckle 7 is in engagement with the buckle tongue 11.

Method step 211 is then carried out, which involves again detecting by the seat detector 5 whether the seating position is also still occupied. If that is the case, method step 207 is repeated and the first alarm is possibly produced again in method step 209. If the seating position is no longer occupied, the method 200 is finished.

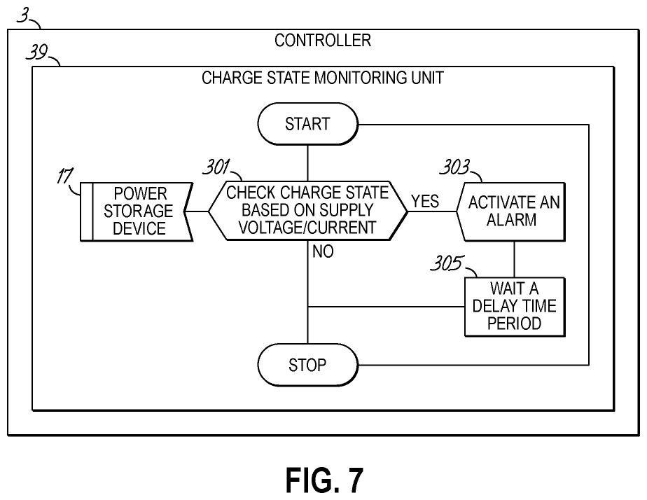

FIG. 7 shows the method steps for checking the charge state 300, the controller 3 having a charge state monitoring unit 39 for that purpose. The charge state monitoring unit 39 is adapted in a method step 301 to check the charge state based on the supply voltage and/or supply current provided by the power storage device 17 (see FIG. 1A). If the charge state is too low, then an alarm is produced in a method step 303. Then, method step 305 involves waiting for the expiry of a delay time and if within that waiting time, the method is interrupted and the power source replaced the method is broken off. Otherwise, method step 300 is repeated until the charge state of the power storage device is no longer below a minimum charge state.

Thus, the invention has been described by reference to the embodiments discussed above. It will be recognized that these embodiments are susceptible to various modifications and alternative forms well known to those of skill in the art. Many modifications in addition to those described above may be made to the structures and techniques described herein without departing from the invention. Accordingly, although specific embodiments have been described, these are examples only and are not limiting upon the scope of the invention

What is claimed is:

1. A personal securing system for securing people in a vehicle with reversibly mounted vehicle seats, the personal securing system comprising:
a seat detector which is fitted into a seat surface of a vehicle seat and is adapted to monitor occupancy of the vehicle seat and to provide a signal when the vehicle seat is occupied,
at least one belt buckle which is connected to the vehicle seat and is adapted to be brought into engagement with a buckle tongue, wherein the belt buckle further has a belt buckle detector adapted to monitor a position of the buckle tongue and to provide a signal when the belt buckle is in engagement with the buckle tongue,
a controller which is connected to the vehicle seat and which is connected in signal-conducting relationship to the seat detector and the belt buckle detector, the controller processing signals recorded by the seat detector and the belt buckle detector and providing an alarm signal when, with a vehicle seat being occupied, the respective belt buckle is not in engagement with the buckle tongue, and
an alarm device connected in signal-conducting relationship to the controller for producing an alarm after reception of an alarm signal,
wherein the controller has an autonomous power storage device electrically decoupled from the vehicle for providing a dedicated power supply for the controller, the seat detector, the belt buckle detector and the alarm device.

2. The personal securing system of claim 1, wherein the controller is adapted to provide the alarm signal to the alarm device, only after expiration of a delay time after detection of a seat occupancy.

3. The personal securing system of claim 2, wherein the controller includes a delay circuit for specifying the delay time and the power storage device provides a power supply for the delay circuit.

4. The personal securing system of claim 1, wherein the controller includes the alarm device, and the alarm device includes at least one of an acoustic and an optical alarm device for producing at least one of an alarm sound and an optical alarm.

5. The personal securing system of claim 1, wherein the controller includes a charge state monitoring unit connected in signal-conducting relationship to the power storage device and in signal-conducting relationship to the alarm device, and wherein the alarm signal is a first alarm signal and the charge state monitoring unit is further adapted to provide a second alarm signal to the alarm device when the charge state falls below a predefined minimum charge state.

6. The personal securing system of claim 1, wherein the controller is respectively connected by a power line and a signal line to the seat detector, the belt buckle detector and also the alarm device.

7. The personal securing system of claim 1, wherein the belt buckle detector includes a Hall effect sensor and a magnet, in particular a permanent magnet, wherein the Hall effect sensor is adapted to detect a change in position of the buckle tongue by a change in an acting magnetic field.

8. The personal securing system of claim 1, further comprising:
a transmitting unit connected to the controller in signal-conducting relationship, in particular wired by a signal line, wherein the transmitting unit is connected by a wireless signal connection to a receiver unit associated with a vehicle and is adapted to send the alarm signal provided by the controller to the receiver unit.

9. The personal securing system of claim 8, wherein the receiver unit is connected in signal-conducting relationship, by a signal line, to a signal processing unit associated with the vehicle, wherein the signal processing unit is programmed to process the signals provided by the transmitting unit and received by the receiver unit to carry out at least one of the following method steps:
providing at least one of an optical and an acoustic signal when an alarm signal was provided by the controller,
providing a signal to a display unit, the signal containing information about the signals detected by at least one of the seat detector and the belt buckle detector, and
providing a signal to a central vehicle control system, the signal containing information about the signals detected by the at least one of the seat detector and the belt buckle detector.

10. The personal securing system of claim 3, wherein the controller includes the alarm device, and the alarm device includes at least one of an acoustic and an optical alarm device for producing at least one of an alarm sound and an optical alarm,
wherein the controller includes a charge state monitoring unit connected in signal-conducting relationship to the power storage device and in signal-conducting relationship to the alarm device, and wherein the alarm signal is a first alarm signal and the charge state monitoring unit is further adapted to provide a second alarm signal to the alarm device when the charge state falls below a predefined minimum charge state,
wherein the controller is respectively connected by a power line and a signal line to the seat detector, the belt buckle detector and also the alarm device,
wherein the belt buckle detector includes a Hall effect sensor and a magnet, in particular a permanent magnet, wherein the Hall effect sensor is adapted to detect a change in position of the buckle tongue by a change in an acting magnetic field,
the personal securing system further comprising a transmitting unit connected to the controller in signal-conducting relationship, in particular wired by a signal line, wherein the transmitting unit is connected by a wireless signal connection to a receiver unit associated with a vehicle and is adapted to send the alarm signal provided by the controller to the receiver unit,
wherein the receiver unit is connected in signal-conducting relationship, by a signal line, to a signal processing unit associated with the vehicle, wherein the signal processing unit is programmed to process the signals provided by the transmitting unit and received by the receiver unit to carry out at least one of the following method steps:
providing at least one of an optical and an acoustic signal when an alarm signal was provided by the controller,
providing a signal to a display unit, the signal containing information about the signals detected by at least one of the seat detector and the belt buckle detector, and
providing a signal to a central vehicle control system, the signal containing information about the signals detected by the at least one of the seat detector and the belt buckle detector.

11. A seat assembly for reversible coupling to a vehicle, comprising:
the personal securing system of claim 1, and
a vehicle seat having a seat surface into which the seat detector is fitted and a quick-action coupling device for fast reversible coupling of the vehicle seat to the vehicle, wherein the belt buckle is operatively connected to the vehicle seat and the controller is arranged at the vehicle seat.

12. A passenger vehicle for transporting passengers, comprising:
the seat assembly of claim 11,
at least one retractor restraint system having a buckle tongue which can be brought into engagement with the corresponding belt buckle of the personal securing system,
at least one coupling interface which can be reversibly coupled to the corresponding quick-action coupling device of the vehicle seat, and
a vehicle battery for providing a power supply for the vehicle, wherein the power storage device of the personal securing system is an autonomous power storage device and is electrically decoupled from the vehicle battery.

13. A method of securing people in vehicles, comprising:
providing a seat assembly with an autonomous power storage device as a power supply for a controller, a seat detector, a belt buckle detector and an alarm device,
reversibly fitting a vehicle seat of the seat assembly with a personal securing system,
providing the power supply by the power storage device for the controller, the belt buckle detector, the seat detector and the alarm device,
detecting occupancy of the vehicle seat by the seat detector,
detecting a closed state in which a belt buckle is in engagement with a buckle tongue by the belt buckle detector,
processing information detected by the seat detector and the belt buckle detector, specifically with at least one of the controller and a signal processing unit,
providing a first alarm signal when, with a vehicle seat occupied, the associated belt buckle is not moved into a closed state in engagement with the buckle tongue, and
producing a first alarm after reception of the first alarm signal.

14. The method of claim 13, further comprising:
checking a charge state of the power storage device,
providing a second alarm signal when the charge state is below a predefined minimum charge state, and
producing a second alarm after reception of the second alarm signal.

15. The method of claim 13, further comprising:
specifying a delay time by a delay circuit of the personal securing system, wherein the first alarm signal is provided only after expiration of the delay time, after detection of a seat occupancy and the first alarm is produced.

16. The method of claim 15, wherein the first alarm signal is produced immediately when, after expiration of the delay time, the belt buckle is separated from the buckle tongue again and seat occupancy is still detected.

17. The method of claim 13, further comprising:
replacing or charging the power storage device,
checking a current supply or a voltage supply,
producing a first alarm signal adapted that the current supply or voltage supply is present,
checking the belt buckle detector,
again producing the first alarm signal when the belt buckle detector does not provide a signal and/or does not detect engagement of the belt buckle and the buckle tongue,
producing a second alarm signal when the belt buckle detector provides a signal and/or detects engagement of the belt buckle and the buckle tongue,
checking the seat detector,
again producing the first alarm signal when the seat detector does not provide a signal and/or does not detect seating position occupancy, and
again producing the second alarm signal when the seat detector provides a signal and/or detects a seat occupancy.

18. The method of claim 14, further comprising:
specifying a delay time by a delay circuit of the personal securing system, wherein the first alarm signal is provided only after expiration of the delay time after detection of a seat occupancy and the first alarm is produced, wherein the first alarm signal is produced immediately when, after expiration of the delay time, the belt buckle is separated from the buckle tongue again and seat occupancy is still detected,
replacing or charging the power storage device,
checking a current supply or a voltage supply,
producing a first alarm signal adapted that the current supply or voltage supply is present,
checking the belt buckle detector,
again producing the first alarm signal when the belt buckle detector does not provide a signal and/or does not detect engagement of the belt buckle and the buckle tongue,
producing a second alarm signal when the belt buckle detector provides a signal and/or detects engagement of the belt buckle and the buckle tongue,
checking the seat detector,
again producing the first alarm signal when the seat detector does not provide a signal and/or does not detect seating position occupancy, and
again producing the second alarm signal when the seat detector provides a signal and/or detects a seat occupancy.
